(19) United States
(12) Patent Application Publication
(10) Pub. No.: US 2004/0167830 A1
(43) Pub. Date: Aug. 26, 2004

(54) Network integration alignment method

(76) Inventors: Pranab Shah, Washington, DC (US); Paul Vogel, Washington, DC (US)

Correspondence Address: WEISS & MOY PC, 4204 NORTH BROWN AVENUE, SCOTTSDALE, AZ, 85251, US

(21) Appl. No.: 10/349,527

(22) Filed: Jan. 22, 2003

(51) Int. Cl. G06F 17/60

(52) U.S. Cl. 705/28

(57) ABSTRACT

A system and method for transporting and distributing large numbers of items. The system and method includes a plurality of plants, with items being transported between the plants and distributed within them. In one embodiment, the items are characterized according to shape, and are assigned to plants for distribution and are organized for transportation between plants based on shape. In another embodiment, the items have assigned thereto geographic codes, and are assigned to plants for distribution and are organized for transportation between plants based on these geographic codes. In another embodiment, both shape and geographic code are considered in the assignment of plants.

### FIELD OF THE INVENTION

This invention relates generally to systems and methods for the efficient transportation of objects from an origination point to a destination point including, more particularly and in one embodiment, an integrated system and method for transporting and distributing mail objects from an origination point to a destination point.

### BACKGROUND OF THE INVENTION

In fiscal year 2000, the United States Postal Service delivered approximately 208 billion pieces of mail. The average daily volume of mail delivered during fiscal year 2000 was 500 million pieces.

At present, the process of delivering the mail is a relatively complicated one. That process can be broken down into two components: (a) transportation and (b) distribution. The term “transportation” as used herein is intended to refer to the nodes and routes, which define the flow of mail (or other objects) between plants/processing facilities (or other sorting points). Transportation includes the inter-plant transportation network and the plant to delivery unit networks. (A delivery unit is a post office, station or branch that has mail delivery functions to the point of final delivery for a mail item.) It does not include activity within the plants themselves.

The term “distribution” as used herein refers to the combination of equipment, processes and plants that sort mail (or other objects). Distribution generally takes place between the point at which originating mail is picked up from its point of origin and the point at which it reaches its point of final delivery.

The transportation of mail is assisted by the use of five and preferably nine digit zip codes, which refer to defined geographic areas. The first three numbers in a zip code define zip code areas, and currently there are 932 different zip code areas within the U.S. mail system. The zip code area defines a larger geographic area than a five digit zip code, and the five digit zip code defines a larger geographic area than the nine digit zip code. For a nine digit zip, the area that it defines will be within both the five digit and three digit codes that it contains. To date, the transportation of mail items has not been configured around three digit zip code areas. (It should be noted that references herein to zip codes and zip code areas are not intended to be limited to the current system employed by the United States Postal Service, but instead is meant to include the use of any geographic code system, according to which geographic areas are defined, and preferably at increasing levels of specificity, through the use of a code system.)

It must also be noted that mail items come in varying shapes. Examples of current mail shapes include flat-size, letter-size, parcels, and outsides. Currently, plants process more or less all shapes of mail. However, because mail-processing equipment is generally shape-specific; i.e., can only process one shape of mail item, it is inefficient to locate in each plant every type of processing equipment. Moreover, currently, transportation of mail is organized according to mail class, rather than according to mail shape.

A need continually exists to improve and further optimize the transportation and distribution process where a large number of objects must be processed, including particularly in one example a large number of mail objects. Such improvement may rely on the use of three digit zip code areas, or the like, in optimizing plant location. In addition, or alternatively, such improvement may rely on the use of shape-based criteria in organizing the transportation of mail items (or the like) between plants and their distribution within plants.

The present invention satisfies these needs and provides other, related, advantages.

### SUMMARY OF THE INVENTION

It is an object of the present invention to provide an improved system and method for transporting and distributing large numbers of objects in which plant locations are optimized using three digit zip code areas, or the like.

It is a further object of the present invention to provide an improved system and method for transporting and distributing large numbers of objects in which shape-based criteria are utilized to organize the transportation and/or distribution of mail items or the like.

### BRIEF DESCRIPTION OF THE PREFERRED EMBODIMENTS

In accordance with one embodiment of the present invention, a method for transporting and distributing a large number of items from an origination point to a destination point is disclosed. The method comprises the steps of: providing a plurality items to be delivered from an origination point to a destination point; wherein a subset of the plurality of items has a first shape; wherein a subset of the plurality of items has a second shape; providing a plurality of plants; transporting at least a portion of the plurality of items from a first the plant to a second the plant wherein an identity of the second plant is decided at least in part based on the shape of the at least a portion of the plurality of items having the first shape; and distributing the at least a portion of the plurality of items having the first shape within the first plant.

In accordance with another embodiment of the present invention, a method for transporting and distributing a large number of items from an origination point to a destination point is disclosed. The method comprises the steps of: providing a plurality items to be delivered from an origination point to a destination point; wherein the items are mail items; assigning to substantially all of the plurality of mail items a single originating geographic code and a single destinating geographic code from a plurality of geographic codes; providing a plurality of plants; transporting at least a portion of the plurality of [symbol] one of the originating geographic code and the destinating geographic code.

In accordance with yet another embodiment of the present invention, a method for transporting and distributing a large number of items from an origination point to a destination point is disclosed. The method comprises the steps of: providing a plurality items to be delivered from an origination point to a destination point; wherein a subset of the plurality of items has a first shape; wherein the first shape comprises at least one of letters and flats; wherein a subset of the plurality of items has a second shape; wherein the second shape comprises at least one of parcels and outsides; providing a plurality of plants; transporting at least a portion of the plurality of items from a first the plant to a second the plant wherein an identity of the second plant is decided at least in part based on the shape of the at least a portion of the plurality of items having the first shape; and distributing the at least a portion of the plurality of items having the first shape within the first plant.

The foregoing and other objects, features, and advantages of the invention will be apparent from the following, more particular, description of the preferred embodiments of the invention, as illustrated in the accompanying drawings.

### BRIEF DESCRIPTION OF THE DRAWINGS

FIG. 1 is a flow-style chart illustrating the mail supply chain.

FIG. 2 is a block diagram illustrating the mail processing system at a general level.

### DETAILED DESCRIPTION OF THE PREFERRED EMBODIMENTS

This invention is concerned with a system and method for the efficient transportation of objects from an origination point to a destination point. Preferably, the objects pass through an intermediate sorting point, and are there sorted so as to aid in the efficient transportation of the objects through the system. In one embodiment, the objects are mail pieces. However, other, non-mail objects, could also be transported from an origination point to a destination point using the system and method of the present invention.

The system and method of the present invention is intended to accommodate the transportation and, in one embodiment, the distribution, of extremely large numbers of objects. In one preferred embodiment, the system and method may be used in the efficient transportation and distribution of extremely large numbers of mail items. The system and method of the present invention, in one embodiment, is intended to optimize the delivery of mail objects in such volumes as those experienced by the U.S. Postal Service in fiscal year 2000. The system and method integrates the transportation and distribution aspects of object delivery to achieve improved efficiency—and specifically an efficiency level greater than that provided if transportation and distribution are treated in a non-integrated manner.

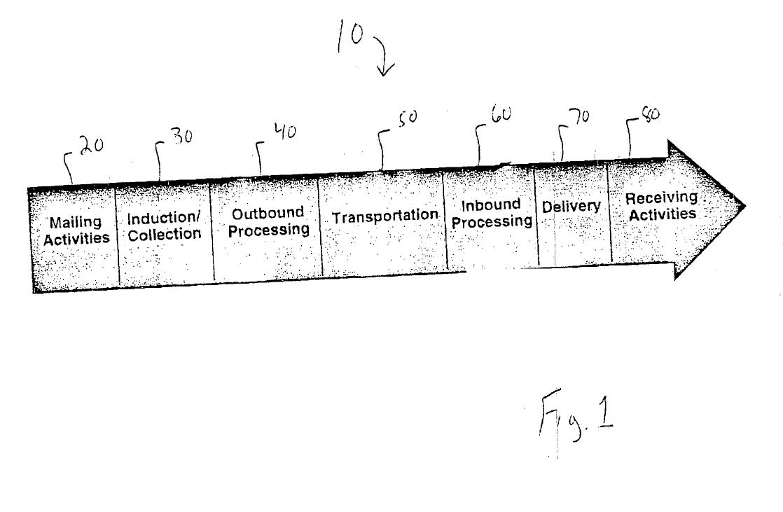

Referring now to FIG. 1, an illustration of the full mail supply chain 10 is shown. It begins with mailing activities 20, which relates to the mailing of mail pieces from the point of origin. The next link in the chain is induction/collection 30, where mail enters the mailstream. The mail is then processed for transportation at outbound processing 40. The next step is transportation 50 in the direction of the point of final delivery. The mail is then subjected to inbound processing 60 and delivery 70. Finally, receiving activities 80 refers to those in connection with the receipt of the mail at its point of final delivery. Each step in the mail supply chain 10 is necessary in the accurate and efficient delivery of large volumes of mail items.

In one embodiment, the system and method of the present invention utilizes three digit zip code areas to aid in efficient transportation and distribution of mail items. Although there are a number of other components, the backbone of the mail transportation and distribution system is the plant/processing facility. It is in these facilities that mail distribution, i.e., sorting, takes place. Currently, there are approximately 450 plants in the system. The efficient transportation of mail to plants improves the efficiency of both the transportation and distribution systems. By ensuring that mail is routed to the optimally located plant, transportation costs are reduced and delays limited. Moreover, by ensuring that plants are distributing mail within a proper region (as defined by the assignment of specific three digit zip code areas to plants), as opposed to distributing mail from beyond the proper region, the distribution process as well proceeds in a more efficient manner.

In order to utilize plants optimally within the transportation and distribution system, mail items are preferably routed to plants based on the three digit zip code area of the mail items. Thus, each three digit zip code is preferably assigned to a single plant for origination processing (or for separation to a concentrator, discussed below). Each three digit zip code is also assigned to one plant for destinating processing (or transportation to a disperser, discussed below). In this regard, plants are preferably receiving mail within one or more three digit zip code areas, with the particular zip code areas chosen being those most efficiently reached utilizing the transportation system. In most cases, the zip code areas will be those in the closest geographic proximity to the particular plant but, where transportation efficiencies require otherwise, these considerations will take precedence.

Optimal routing of mail to plants takes place at two points along the mail supply chain 10. It takes place first at outbound processing 40, where outgoing mail from three digit zip code areas using optimization criteria is preferably routed to the desired plant, based on the three digit zip code area of the sender. It takes place a second time at inbound processing 60, where inbound mail from three digit zip code areas using optimization criteria is preferably routed to the desired plant, based on the three digit zip code area of the recipient. Thus, for example, a mail item from three digit zip code area 123 that is travelling to three digit zip code area 456 may be routed to plant A for inbound processing 40 because zip code area 123 has been assigned to plant A, and to plant B for outbound processing, because zip code area 456 has been assigned to plant B. (That mail item may pass through intermediate processing facilities between the outbound and inbound plants, as discussed below.)

As an additional element, the shape of the items transported preferably also forms at least a component of process of optimally locating and assigning plants, in addition to or instead of the use of three digit zip code areas. Mail items come in varying shapes. Examples of current mail shapes include: (a) flat-size mail—mail that is within the dimensions of 15 inches long, 12 inches high, and ¾ of an inch thick; (b) letter-size mail—mail that is within the dimensions of 11 and 1/2 inches long, 6 and 1/8 inches high, and 1/4 inch thick; (c) parcels—mail items outside the dimensions of flats and letter-sized and fitting within a mail sack or container; and (d) outsides—mail that cannot be placed into a sack or container because of its size, weight, shape or contents. (Of course, it should be recognized that other shapes may be introduced in the future, or may be practiced in other mail systems or in integrated transportation/distribution systems of non-mail items.)

Because mail-processing equipment is generally shape-specific; i.e., can only process one shape of mail item, it is inefficient to locate in each plant every type of processing equipment. Accordingly, a preferred component of the system and method of the present invention is that plants process only mail of one or more (though less than all) shapes. For example, one plant may only process parcels, another may only process flats, yet another may process flats and letters, and so on. (Because of the similarity of their shape, it will be preferred to treat letters and flats in like manner.) This differentiation allows advantage to be taken of economies of scale that may be achieved by having mail of similar shape be processed in dedicated plants. For less populous areas, it may be preferred to provide plants that process most or all mail shapes. However, preferably, more than a majority of plants in the system and method of the present invention process mail based on shape, with the plant processing fewer than all possible shapes.

When distribution is optimized based on shape by focusing plants on only one or more but fewer than all mail shapes, it can be seen that transportation between plants should also be determined at least in part based on the shape of the items being transported.

It follows from the use of shape-based distribution that, where used in combination with three digit zip codes to optimize transportation and/or distribution, it is preferred to assign mail items from particular three digit zip code areas to more than one plant, depending on the shape of the mail item. For example, flats from zip code area 123 may be assigned to plant A, while parcels from zip code area 123 may be assigned to plant B. (Plant B, in this situation, may also be considered a concentrator, discussed below, to the extent that it receives parcels from zip code areas other than 123.) On the other hand, it is preferred that all mail for a particular three digit zip code first be transported to its assigned plant for shape separation, with separated mail of particular shapes being transported to other plants (or concentrators) for further processing as necessary. Thus, in the example, both flats and parcels from zip code area 123 would first go to plant A for separation, with flats remaining in plant A for further processing and parcels being transported to plant B for further processing.

Accordingly, the assignment of mail items to plants and plant location is preferably based both on the three digit zip code area and shape of mail items processed therein—though it may be based on only one of these criteria.

Plant location and assignment according to three digit zip code areas and shape is preferably determined through a four step modelling approach. In Step 1, a preliminary network design is overall strategic direction for the remainder of the modelling process is determined.

In Step 3, implementation modelling occurs, with a finalized network being developed. Step 4 is a simulation, in which the outputs of Steps 1-3 are tested using simulation modelling. The modelling process yields a network having desired efficiency for an acceptable cost. The modelling process should, preferably, be software-assisted, given the complexity of the problem and the large number of potential variables. It should also consider different “what if” scenarios that might impact on the network, including for example the unanticipated closing of a plant or other facility.

Another aspect of the system and method concerns the physical transportation of mail (or other objects) within the network. In this connection, it must be noted that mail items are currently differentiated, in addition to by originating zip code, destinating zip code, and shape—by classification. Mail classes presently include first-class mail, Priority Mail, Express Mail, Periodicals, Standard Mail (A) and Standard Mail (B), though of course these may change and/or other mail classes may be introduced to the system. Different mail classes have different transportation needs. For example, Express Mail items need to be delivered faster than first-class mail items. (Because mail processing machines can efficiently process different classes of mail of a certain shape, plants should developed. In this step, the optimal level of shape differentiation is determined, as well as three digit zip code assignments—with cost driving the process.

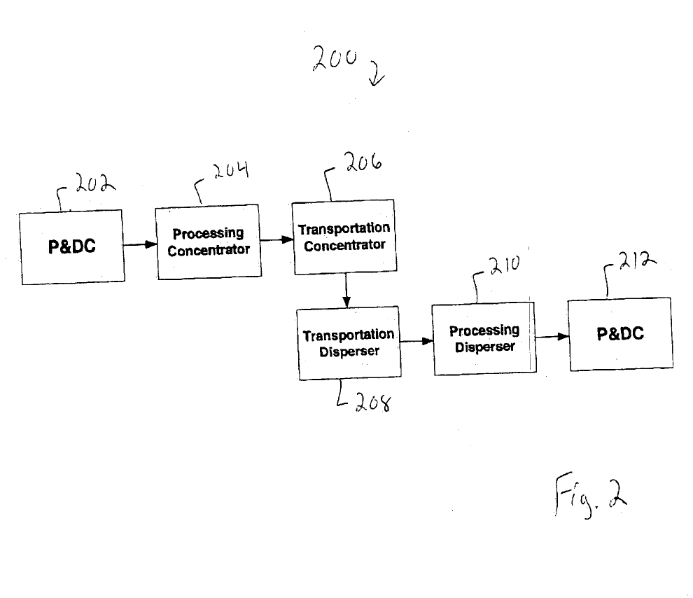

While the plants are the backbone of the system and method, the network preferably has other components as well. As part of this analysis, the role of other actors should also be considered. Referring now to the block diagram of FIG. 2, illustration is made at a general level of the mail processing system 200. From an originating plant and distribution (“P&DC”) 202, mail may be transported to a processing concentrators 204 (facilities that receive originating mail from plants for processing), then to a transportation concentrator 206 (facilities that receive originating mail for the purpose of consolidating transportation), next to a transportation disperser 208 (facilities that receive destinating mail from multiple origination points for dispersement to local processing dispersers or plants), from there to a processing disperser 210 (facilities that receive destinating mail and perform destinating sorting for a set of plants), and then to a destinating P&DC 212. The optimal number and location of concentrators 204 and 206 and dispersers 210 and 212, as well as their assignment to particular plants, is preferably determined as part of Step 1.

In Step 2, the strategic direction is refined based on scenario analyses and feedback from management in the field. During this step, assumptions and results are validated, and preferably not be limited by class unless efficiency will be promoted by such assignment in a particular situation.)

As noted above, concentrators and dispersers are preferably used between plants to assist both with transportation and distribution. To provide for more efficient transportation, it is preferred to assign to each plant a concentrator and disperser for each mail item class, unless the plant handles that class itself.

While, in a preferred embodiment, the system and method of the present invention may be utilized for the transportation and distribution of mail items, it should be understood that it could be used for the transportation and distribution of non-mail items as well. In the event of such application, certain substitutions to the elements of the method and system of the present invention will be made, as necessary, to permit use with non-mail items. For example, instead of three digit zip codes, some other designation may be used to identify origination and/or destination of items—including for example state or geographic region (e.g., city, county, country, multi-state region, etc.), store or other component in the network, or the like—for purposes of assigning shipment items to plant locations. Instead of shape, processing may be differentiated by some other criteria concerning the non-mail item and/or its packaging that will allow economies of scale to be effectively utilized, such as weight, shelf-life, or the like.

I claim:

1. A method for transporting and distributing a large number of items from an origination point to a destination point comprising the steps of:
providing a plurality items to be delivered from an origination point to a destination point;
wherein a subset of said plurality of items has a first shape;
wherein a subset of said plurality of items has a second shape;
providing a plurality of plants;
transporting at least a portion of said plurality of items from a first said plant to a second said plant wherein an identity of said second plant is decided at least in part based on said shape of said at least a portion of said plurality of items having said first shape; and
distributing said at least a portion of said plurality of items having said first shape within said first plant.

2. The method of claim 1 wherein said items are mail items.

3. The method of claim 2 further comprising the steps of:
assigning to substantially all of said plurality of mail items an originating geographic code and a destinating geographic code; and
determining an identity of said second plant at least in part based on one of said originating geographic code and said destinating geographic code.

4. The method of claim 3 wherein said plurality of geographic codes comprises a listing of three digit zip code areas.

5. The method of claim 1 wherein said at least some of said plurality of items are organized for transport between said first said plant and said second said plant based on said shape of said at least some of said plurality of items.

6. The method of claim 4 wherein mail items travelling from an originating three digit zip code area to a destinating three digit zip code are assigned to one said plant for outbound processing based on said originating three digit zip code area and to another said plant for inbound processing based on said destinating three digit zip code area.

7. The method of claim 1 further comprising the step of providing a transportation and distribution system having a plurality of plants and adapted to transport items having one of a plurality of possible shapes therebetween, and wherein each possible shape of said items is assigned to at least one said plant within said transportation and distribution system.

8. The method of claim 7 wherein said step of assigning each said possible shape to at least one said plant within said transportation and distribution system is determined through a four step modelling approach.

9. The method of claim 8 in which said four step modelling approach comprises the steps of developing a preliminary network design, refining the strategic direction based on scenario analyses and feedback from management in the field, implementation modelling, and a simulation in which testing of the outputs of the first three steps are tested.

10. The method of claim 7 wherein said possible shapes include letters, flats, parcels and outsides.

11. A method for transporting and distributing a large number of items from an origination point to a destination point comprising the steps of:
providing a plurality items to be delivered from an origination point to a destination point;
wherein said items are mail items;
assigning to substantially all of said plurality of mail items a single originating geographic code and a single destinating geographic code from a plurality of geographic codes;
providing a plurality of plants;
transporting at least a portion of said plurality of mail items from a first said plant to a second said plant; and
determining an identity of said second plant at least in part based on one of said originating geographic code and said destinating geographic code.

12. The method of claim 11 wherein said plurality of geographic codes comprises a listing of three digit zip code areas.

13. The method of claim 12 wherein mail items travelling from said originating three digit zip code area to said destinating three digit zip code area are assigned to one said plant for outbound processing based on said originating three digit zip code area and to another said plant for inbound processing based on said destinating three digit zip code area.

14. The method of claim 11 further comprising the step of providing a transportation and distribution system having a plurality of plants and adapted to transport mail items therebetween, and wherein each zip code area associated with any of said mail items is assigned to at least one said plant within said transportation and distribution system.

15. The method of claim 14 wherein said step of assigning each said zip code area to at least one said plant within said transportation and distribution system is determined through a four step modelling approach.

16. The method of claim 15 in which said four step modelling approach comprises the steps of developing a preliminary network design, refining the strategic direction based on scenario analyses and feedback from management in the field, implementation modelling, and a simulation in which testing of the outputs of the first three steps are tested.

17. A method for transporting and distributing a large number of items from an origination point to a destination point comprising the steps of:
providing a plurality items to be delivered from an origination point to a destination point;
wherein a subset of said plurality of items has a first shape;
wherein said first shape comprises at least one of letters and flats;
wherein a subset of said plurality of items has a second shape;
wherein said second shape comprises at least one of parcels and outsides;
providing a plurality of plants;
transporting at least a portion of said plurality of items from a first said plant to a second said plant wherein an identity of said second plant is decided at least in part based on said shape of said at least a portion of said plurality of items having said first shape; and
distributing said at least a portion of said plurality of items having said first shape within said first plant.
